(19) United States
(12) Patent Application Publication
(10) Pub. No.: US 2025/0122084 A1
(43) Pub. Date: Apr. 17, 2025

(54) Electrochemically Active-Material Structures Comprising Silicon and Inert Elements and Methods of Fabricating Thereof

(71) Applicant: Gru Energy Lab Inc., San Jose, CA (US)

(72) Inventors: Xiahui Yao, San Jose, CA (US); Xiaohua Liu, Mountain View, CA (US); Sa Zhou, San Jose, CA (US); Song Han, Foster City, CA (US)

(21) Appl. No.: 18/914,577

(22) Filed: Oct. 14, 2024

Related U.S. Application Data
(60) Provisional application No. 63/590,342, filed on Oct. 13, 2023.

(51) Int. Cl. C01B 33/033

(52) U.S. Cl. CPC C01B 33/033; B01J 37/348; C01B 7/00; C01B 33/02; C01B 33/06; C01B 33/20; B01J 2219/00713; C01P 2002/52; C01P 2006/40

(57) ABSTRACT

Described herein are electrochemically active-material structures comprising silicon and one or more inert elements, chemically and/or atomically dispersed in these electrochemically active-material structures. Also described are negative battery electrodes and lithium-ion electrochemical cells comprising such electrochemically active-material structures as well as methods of fabricating such structures, electrodes, and lithium-ion electrochemical cells. Some examples of atomically-dispersed inert elements include, but are not limited to, hydrogen (H), carbon (C), nitrogen (N), and chlorine (Cl). Unlike silicon, inert elements do not interact with lithium at an operating voltage of the negative battery electrode and therefore do not contribute to the overall cell capacity. At the same time, these inert elements help to mitigate silicon swelling by operating as a mechanical buffer, support structure, and/or additional conductive pathways. Such electrochemically active-material structures can be formed by reacting (chemically or electrochemically) one or more precursors that include silicon and corresponding inert elements.

### CROSS-REFERENCE TO RELATED APPLICATIONS

This application claims the benefit under 35 U.S.C. § 119 (e) of U.S. Provisional Patent Application 63/590,342 (Attorney Docket No. GRUEP029P), filed on 2023 Oct. 13, which is incorporated herein by reference in its entirety for all purposes.

### BACKGROUND

Graphite is the most widely adopted negative electrode active material for lithium-ion batteries. However, with the increasing demand for higher energy density to be provided by lithium-ion batteries, the specific capacity and volumetric capacity provided by graphite materials can't meet such demand. High-capacity materials, such as silicon, are very desirable for various battery applications because of their high gravimetric and volumetric capacities. However, many high-capacity materials undergo significant volume changes during charge-discharge cycling (e.g., incorporation-removal of lithium ions). The repeated cycling and corresponding volume changes can cause pulverization of these materials and/or loss of electrical connections between these materials and other electrode components. Conventional integration of high-capacity materials into electrodes typically results in high irreversible capacity losses, excessive solid electrolyte interphase (SEI) formation, and losses of electrical contacts within electrodes formed from these materials, all of which are highly undesirable. These issues have limited the application of high-capacity active materials in batteries.

What is needed are electrochemically active-material structures comprising silicon and/or other high-capacity materials capable of withstanding repeated charge-discharge cycling while maintaining the integrity and performance of the electrodes.

### SUMMARY

Described herein are electrochemically active-material structures comprising silicon and one or more inert elements, chemically or even atomically dispersed in these electrochemically active-material structures. Also described are negative battery electrodes and lithium-ion electrochemical cells comprising such electrochemically active-material structures as well as methods of fabricating such structures, electrodes, and lithium-ion electrochemical cells. Some examples, of inert elements include, but are not limited to, hydrogen (H), carbon (C), nitrogen (N), and chlorine (Cl). Unlike silicon, inert elements do not interact with lithium at an operating voltage of the negative battery electrode and therefore do not contribute to the overall cell capacity. At the same time, these inert elements help to mitigate silicon swelling by operating as a mechanical buffer, support structure, and/or additional conductive pathways. Such electrochemically active-material structures can be formed by reacting (chemically or electrochemically) one or more precursors that include silicon and corresponding inert elements.

Clause 1. A method of fabricating electrochemically active-material structures, for negative battery electrodes in lithium-ion electrochemical cells, using a homogenous liquid-phase mixture, the method comprising: providing one or more precursors dissolved in a liquid solvent and forming the homogenous liquid-phase mixture in which one or more precursors are atomically dispersed, wherein the one or more precursors comprise silicon and one or more inert elements; and reacting the one or more precursors using reaction conditions that induce formation of the electrochemically active-material structures by simultaneously extracting the silicon and the one or more inert elements from the one or more precursors and incorporating the silicon and the one or more inert elements into the electrochemically active-material structures, wherein: the silicon and the one or more inert elements are chemically dispersed in the electrochemically active-material structures, the electrochemically active-material structures are solid structures forming a suspension in the liquid solvent, the electrochemically active-material structures are characterized by an amorphous silicon phase or a polycrystalline silicon phase while comprising the one or more inert elements in addition to the silicon, and the reaction conditions induce one or both of a chemical reaction and a electrochemical reaction of the one or more precursors.

Clause 2. The method of clause 1, wherein the one or more inert elements are selected from the group consisting of hydrogen (H), carbon (C), nitrogen (N), oxygen (O), magnesium (Mg), fluorine (F), chlorine (Cl), titanium (Ti), sodium (Na), bromine (Br),

Clause 3. The method of clause 1, wherein the one or more inert elements are selected from the group consisting of lithium (Li), boron (B), aluminum (Al), phosphorous (P), sulfur(S), potassium (K), calcium (Ca), scandium (Sc), vanadium (V), chromium (Cr), manganese (Mn), iron (Fe), cobalt (Co), nickel (Ni), copper (Cu), zinc (Zn), gallium (Ga), strontium (Sr), zirconium (Zr), niobium (Nb), molybdenum (Mo), indium (In), lanthanum (La), cerium (Ce), tantalum (Ta), tungsten (W), and bismuth (Bi);

Clause 4. The method of clause 1, wherein the reaction conditions comprise introducing a reducing agent having a reducing potential more negative than any of the one or more precursors dissolved in the liquid solvent.

Clause 5. The method of clause 1, wherein the reaction conditions comprise introducing a reducing agent having a reducing potential more negative than −1V vs. a standard hydrogen electrode.

Clause 6. The method of clause 1, wherein the liquid solvent forming the homogenous liquid-phase mixture is selected from the group consisting of an organic solvent and an ionic liquid.

Clause 7. The method of clause 6, wherein the liquid solvent is the organic solvent selected from the group consisting of an alkane, alkene, arene, ether, halogenated solvent, ester, amide, nitrile, and carbonate.

Clause 8. The method of clause 1, wherein the homogenous liquid-phase mixture is free from any solid species before reacting the one or more precursors using the reaction conditions.

Clause 9. The method of clause 1, wherein the one or more precursors are reacted electrochemically in an electrochemical fabrication cell comprising two electrodes operating at a voltage between 2.5V to 6V.

Clause 10. The method of clause 1, wherein the one or more precursors are reacted chemically or electrochemically at a temperature less than 300° C.

Clause 11. The method of clause 1, wherein the one or more precursors comprise a single precursor comprising both the silicon and the one or more inert elements in the single precursor.

Clause 12. The method of clause 11, wherein: the single precursor is selected from the group consisting of an organosilane and a silazane, the organosilane is selected from the group consisting of trichlorosilane, trichloromethylsilane (SiHCl3), trichloroethylsilane, (SiCH3Cl3), trichlorophenylsilane (Si(C6H5)Cl3), and dichlorodimethylsilane (Si(CH3)2Cl2), and Chloro (dimethyl)phenylsilane, and the silazane is selected from the group consisting of hexamethyldisilazane (C6H19NSi2) and 2,2,4,4,6,6-hexamethylcyclotrisilazane.

Clause 13. The method of clause 1, wherein: the one or more precursors comprise a first precursor comprising silicon and a second precursor comprising the one or more inert elements, and the second precursor has a different composition than the first precursor.

Clause 14. The method of clause 1, wherein the one or more precursors comprise a silicon-generating precursor selected from the group consisting of silicon tetrachloride (SiCl4), di-silicon hexachloride (Si2Cl6), silicon tetrabromide (SiBr4), silicon tetraiodide (SiI4), silane (SiH4), di-silane (Si2H6), and tri-silane (Si3H8).

Clause 15. The method of clause 1, wherein the one or more precursors comprise a carbon-generating precursor selected from the group consisting of cholorobenzene (C6H5Cl), dicholorbenze (C6H4Cl2), trichlorobenze (C6H3Cl3), hexacholorbenzene (C6Cl6), dibromobenzene (C6H4Br2), chloromethane (CH3Cl), dicholoromethane (CH2Cl2), trichloromethane (CHCl3), tetrachloro carbon (C2Cl4), and tetrabromo carbon (CBr4).

Clause 16. The method of clause 1, wherein: the one or more precursors comprise a halide selected from the group consisting of a metal halide, a non-metal halide, an amine, and an amide, the metal halide is selected from the group consisting of titanium tetrachloride (TiCl4), iron (III) chloride (FeCl3), aluminum chloride (AlCl3), and Magnesium chloride (MgCl2), the non-metal halide selected from the group consisting of phosphorus trichloride (PCl3), phosphorus pentachloride (PCl5), boron trichloride (BCl3), the amine selected from the group consisting of trimethylamine ((CH₃)₃N) and melamine (C3H6N6), and the amide selected from the group consisting of dimethylformamide (C3H7NO).

Clause 17. The method of clause 1, wherein: the one or more precursors comprise one or more oxygen-generating precursors selected from the group consisting of water (H2O), dissolved oxygen, carbon dioxide (CO2), an alcohol, an oxalate salt, and a nitrate salt, and the electrochemically active-material structures further comprise oxygen.

Clause 18. The method of clause 1, further comprising heat treating the electrochemically active-material structures at a temperature of 50-1100° C.

Clause 19. The method of clause 1, wherein: the homogenous liquid-phase mixture is an electrolyte, provided in an electrochemical fabrication cell comprising two electrodes, the reaction conditions comprise applying a voltage of 2.5-6V between the two electrodes of the electrochemical fabrication cell, and the electrochemically active-material structures comprise at least carbon or oxygen as the one or more inert elements.

Clause 20. The method of clause 1, wherein: the reaction conditions comprise adding lithium biphenyl solution dissolved in tetrahydrofuran (THF) to trigger a chemical reaction to form the electrochemically active-materials, and the electrochemically active-material structures comprise at least carbon or oxygen as the one or more inert elements.

Clause 21. A negative battery electrode for use in a lithium-ion electrochemical cell, the negative battery electrode comprising: electrochemically active-material structures comprising silicon and one or more inert elements, dispersed in the electrochemically active-material structures, wherein: the one or more inert elements are selected from the group consisting of hydrogen (H), lithium (Li), boron (B), carbon (C), nitrogen (N), fluorine (F), sodium (Na), magnesium (Mg), aluminum (Al), phosphorous (P), sulfur(S), chlorine (Cl), potassium (K), calcium (Ca), scandium (Sc), titanium (Ti), vanadium (V), chromium (Cr), manganese (Mn), iron (Fe), cobalt (Co), nickel (Ni), copper (Cu), zinc (Zn), gallium (Ga), bromine (Br), strontium (Sr), zirconium (Zr), niobium (Nb), molybdenum (Mo), indium (In), lanthanum (La), cerium (Ce), tantalum (Ta), tungsten (W), and bismuth (Bi), the electrochemically active-material structure is a single-phase structure through an entire volume of the electrochemically active-material structure without forming a separate phase comprising the one or more inert elements, and a difference of an average atomic ratio of the one or more inert elements (R) in any 1 nm by 1 nm by 1 nm portion of the entire volume is less than % relative to an average atomic ratio of the entire volume.

Clause 22. The negative battery electrode of clause 21, wherein the one or more inert elements are selected from the group of hydrogen (H), boron (B), carbon (C), nitrogen (N), fluorine (F), magnesium (Mg), aluminum (Al), chlorine (Cl), titanium (Ti), chromium (Cr), iron (Fe), gallium (Ga), and bromine (Br).

Clause 23. The negative battery electrode of clause 21, wherein the one or more inert elements are selected from the group of hydrogen (H), boron (B), carbon (C), nitrogen (N), fluorine (F), magnesium (Mg), aluminum (Al), chlorine (Cl), iron (Fe), and bromine (Br).

Clause 24. The negative battery electrode of clause 21, wherein the one or more inert elements are selected from the group of hydrogen (H), carbon (C), nitrogen (N), fluorine (F), aluminum (Al), chlorine (Cl), iron (Fe), and bromine (Br).

Clause 25. The negative battery electrode of clause 21, wherein the one or more inert elements are selected from the group of hydrogen (H), carbon (C), nitrogen (N), and chlorine (Cl).

Clause 26. The negative battery electrode of clause 21, wherein the one or more inert elements have a concentration of 30-50% in the electrochemically active-material structures.

Clause 27. The negative battery electrode of clause 21, wherein the one or more inert elements have a concentration of 5-30% in the electrochemically active-material structures.

Clause 28. The negative battery electrode of clause 21, wherein the one or more inert elements have a concentration of 1-5% in the electrochemically active-material structures.

Clause 29. The negative battery electrode of clause 21, wherein the electrochemically active-material structures further comprise oxygen having a concentration of 5-30% atomic in the electrochemically active-material structures.

Clause 30. The negative battery electrode of clause 21, wherein the one or more inert elements and the silicon form one or more of a homogenous mixture, a solid solution, and an alloy in the electrochemically active-material structures.

### BRIEF DESCRIPTION OF THE DRAWINGS

FIGS. 1A and 1B are schematic reproductions of the transmission electron microscope (TEM) images illustrating a 1.8-micron silicon structure disintegrated due to the lithiation (to a full lithiation capacity), in accordance with some examples.

FIG. 2A is a block diagram illustrating various components of a lithium-ion electrochemical cell comprising electrochemically active-material structures with silicon and one or more inert elements, dispersed in the electrochemically active-material structures, in accordance with some examples.

FIG. 2B is a schematic cross-sectional view of a negative electrode, illustrating electrochemically active-material structures (with silicon and one or more inert elements, dispersed in the electrochemically active-material structures) arranged into negative active material layers supported on the current collector, in accordance with some examples.

FIG. 3 is a schematic illustration of an electrochemically active-material structure, showing silicon, one or more inert elements, and optionally oxygen, being dispersed in the electrochemically active-material structure, in accordance with some examples.

FIG. 4 is a process flowchart corresponding to a method of fabricating electrochemically active-material structures for negative battery electrodes in lithium-ion electrochemical cells, in accordance with some examples.

FIG. 5A illustrates cycle-life profiles for two types of electrochemical cells, i.e., cells fabricated with (1) pure silicon physically mixed with carbon materials and further coated by carbon coating on the surface and cells fabricated with (2) particles containing dispersed silicon, carbon, and oxygen, which has chemically mixed silicon (Si), carbon (C), and oxygen (O) inside the material.

FIGS. 5B and 5C illustrate the difference in energy-dispersive spectroscopy (EDS) mapping analysis of particles containing dispersed silicon, carbon, and oxygen n (FIG. 5B) and physical mixture of silicon particles and carbon particles (FIG. 5C).

### DETAILED DESCRIPTION

In the following description, numerous specific details are outlined to provide a thorough understanding of the present invention. The present invention may be practiced without some or all of these specific details. In other instances, well-known process operations have not been described in detail to avoid obscuring the present invention. While the invention will be described in conjunction with the specific examples, it will be understood that it is not intended to limit the invention to the examples.

### INTRODUCTION

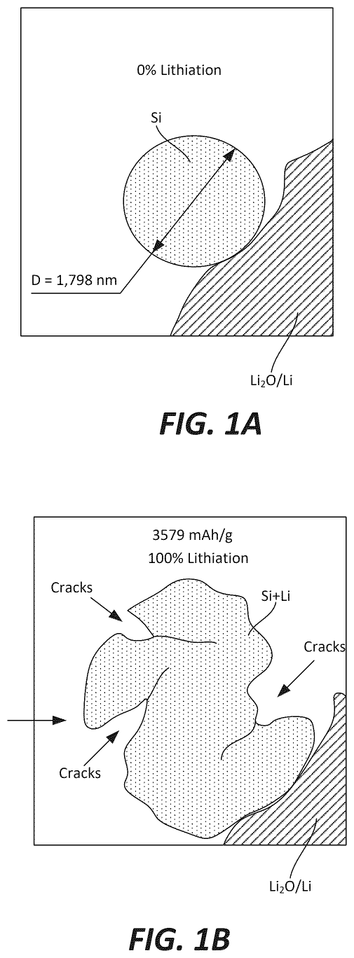

As noted above, high-capacity active materials tend to experience significant volume changes during lithiation (increase in volume/swelling) and delithiation (decrease in volume). At large scales and if not controlled, these volume changes can pulverize active-material structures and disrupt electronic pathways within the electrode layers. For example, FIGS. 1A and 1B are schematic reproductions of the TEM images illustrating a 1.8-micron silicon structure disintegrated due to the lithiation to a full (100%) lithiation capacity, which is about 3579 mAh/g at room temperature. During such lithiation, the silicon structure experiences a volume increase in the volume of about 3.81 times. However, this volume increase is not uniform and causes various internal stresses, which cause the structure to crack and, more generally, to pulverize. These cracks break electronic and ionic connections within the structure and expose additional surfaces for SEI formation, all of which are highly undesirable and result in lithiation/delithiation capacity losses of this structure.

It has been found that introducing various inert elements into silicon structures or, more specifically, chemically and/or atomically dispersing inert elements into silicon structures helps to reduce silicon swelling and also mitigates various aspects of such swelling. Without being restricted to any particular theory, it is believed that inert elements act (1) as buffers for swelling providing additional spacing, and (a) as binding agents surrounding and supporting silicon while silicon is being lithiated (i.e., forms an alloy). Inert elements may also form stronger bonds with the silicon atoms than, e.g., the Si—Si bond or Si—Li bond (in pure silicon particles that may be lithiated). In other words, the bond energy of the inert element to silicon can be higher than the bond energy of Si—Si and Si—Li. For example, silicon (Si) bonding energy with lithium (Li) is 188 KJ/mol, another atom of silicon (Si)-327 kJ/mol, bromine (Br)-343 KJ/mol, carbon (C)-435 KJ/mol, chlorine (Cl)-456 KJ/mol, fluorine (F)-540 KJ/mol, hydrogen (H)-298 KJ/mol, nitrogen (N)-439 KJ/mol, oxygen (O)-798 kJ/mol, and so on.

With that, the inert element-Si bonds will not be broken during the lithiation process, effectively “deactivating” some of the silicon in electrochemically active-material structures. As such, the ability of silicon to lithiate is diminished. This bond-strength feature provides the structural integrity of silicon or, more generally, of the high-capacity active materials during lithiation and delithiation.

Additionally, inert elements may also have no or low alloying volume-expansion effects when lithium is introduced into electrochemically active-material structures during cell charging. Specifically, inert elements can form alloys with lithium with low-volume expansion during lithiation. Inert elements can be inert to lithiation or have much lower lithiation capacity than silicon. The addition of one or more inert elements to silicon reduces the capacity of resulting structures (e.g., in comparison to pure silicon) thereby reducing the volume expansion aspects and preserving the mechanical integrity and performance of these resulting structures (effectively extending the cycle life of these structures and cells formed from these structures).

In some examples, inert elements form ionic bonds with lithium rather than forming metallic alloys. These ionic-bonding aspects also reduce the volume expansion of the electrochemically active-material structures during the lithiation.

The swelling reduction effect can be characterized by measuring the thickness change of the electrochemically active material structures or the negative active material layer during the lithiation process. The ratio of electrode thickness change at a certain level of lithiation, namely “swelling ratio”, can be used to characterize the swelling reduction of the materials.

For purposes of this disclosure, the term “chemically dispersed” is defined as a state in which individual atoms of one or more inert elements are evenly distributed within the electrochemically active-material structures and isolated from each other within the electrochemically active-material structures by silicon. In other words, there is no aggregation or clustering of the atoms of the inert element. For examples, the electrochemically active-material structures are characterized by an amorphous silicon phase or a polycrystalline silicon phase while comprising the one or more inert elements in addition to silicon.

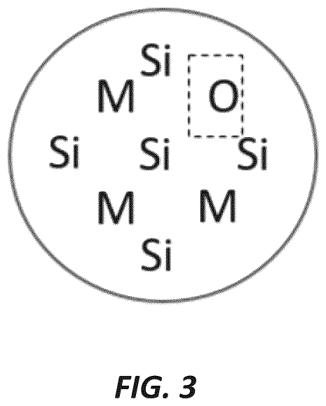

The chemical dispersion should be distinguished from simply combining two sets of structures (e.g., silicon structures and carbon structures) such as by mixing two types of structures and/or depositing one type of structure on another (e.g., coating silicon structures with a carbon layer). The chemical dispersion can only be achieved by simultaneous synthesis of both types of structures (e.g., in a liquid solution). As such, electrochemically active-material structures with chemically dispersed silicon and inert elements can be also referred to as dual-material-co-deposited structures. The bonding/relationship between the inert element and silicon (or other high-capacity materials) can also be characterized as an alloy, a chemical compound, and/or a solid solution. Depending on the inert material, the resulting combination may be referred to as silicide, carbide, oxide, hydride, chloride, fluoride, bromide, nitride, and halide. In some examples, an inert element can be referred to as a dopant. Chemical dispersion is schematically illustrated in FIG. 3.

The “chemical dispersion” may be viewed as a specific example of “atomic dispersion” in which chemical bonds are formed between silicon 130 and inert elements 140 in the bulk phase through out the entire volume of the electrochemically active-material structures 120. This structure can be characterized as an alloy, a chemical compound, and/or a solid solution. But it is distinctly different from a physical mixture, core-shell structured coating, or a composite material with multiple components, which has no chemical interaction between different components or the chemical bonds only existing on the surface or at the interface between different materials.

The ratio of silicon atoms to inert element atoms in electrochemically active-material structures can be defined as R. In any 1 nm*1 nm*1 nm cubic space within the material structure, the R-value can be between 0.001 to 1000, 0.01 to 100, or 0.1 to 10. In other words, the atomic ratio of silicon to the inert element in any 1 nm*1 nm*1 nm cubic space of the entire volume of all electrochemically active-material structures is 0.001-1000, 0.01-100, or 0.1-10, which defines the chemical dispersion of the inert element in the electrochemically active-material structures.

If any region has R>1000, this region is considered to be a pure silicon region. If any region has R<0.001, this region is considered to be a pure inert material region. If both R>1000 and R<0.001, such regions can be found within the same material with phase segregation formed, in which case the inert material is not chemically dispersed. As such, the electrochemically active-material structures are completely free from any 1 nm*1 nm*1 nm cubic spaces that have the atomic ratio of silicon to the inert element greater than 1000 or less than 0.001.

In electrochemically active-material structures described herein and comprising both silicon and one or more inter elements, no such phase segregation is present. For example, the conventional physical mixing of silicon and carbon structures forms a distinct elemental boundary between the silicon structures and the carbon structures, i.e., one side of this boundary is silicon-rich, while the other side of this boundary is carbon-rich. It should be noted that separate silicon and carbon structures have a size of at least about 50 nanometers, which is much greater than 1 nm*1 nm*1 nm cubic spaces. Another conventional example is the coating of carbon on silicon materials or coating silicon materials on carbon structures (e.g., using carbonization of silicon structures, chemical vapor deposition of silicon layers on carbon structures, etc.). In all such coating examples, both silicon-rich regions and carbon-rich regions can be found.

In some examples, the inert element (in electrochemically active-material structures) can contain lithium, making this lithium electrochemically inactive. In other words, no delithiation capacity (or less than the equivalent lithium content capacity) can be extracted, at least from these portions of the active material structure, up to 2.0V vs Li⁺/Li. This lithium-inactivation is realized by fixing the lithium ions to the structural location of the silicon structure or by forming an ionic bond with other inert elements and/or silicon that are also present in the structure. Some examples include, but are not limited to, Si(LiₓO_{y}), Si(LiₓC_{y}), and Si(LiₓN_{y}Cl_{Z}). This lithium-inactivation approach is different from partially lithiated silicon particles, in which the lithium remains in the alloy form and is electrochemically active up to the full extraction, e.g., in Li_{3.75}Si, Li_{3.5}Si, Li_{3.0}Si, Li_{2.0}Si, or LiSi. As noted above, this lithium-inactivation approach involves chemical dispersion (e.g., using one or more precursors comprising silicon and one or more inert elements). The silicon-containing precursor can be different from the inert-element-containing precursor. Alternatively, the same precursor may contain both silicon and at least one inert element.

### Examples of Electrochemical Cells and Negative Electrodes

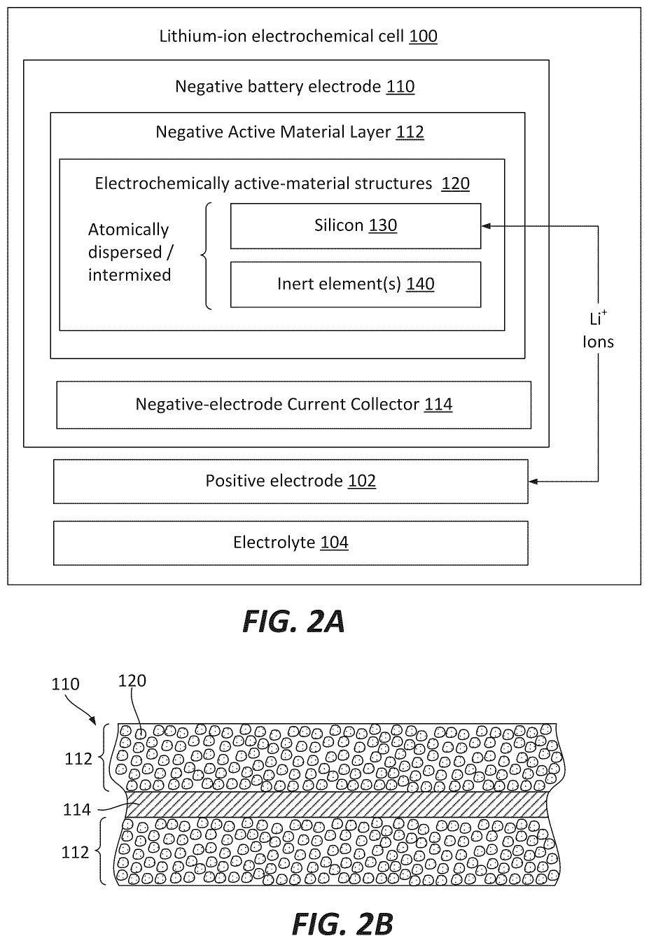

FIG. 2A is a block diagram of a lithium-ion electrochemical cell 100 illustrating various components of the lithium-ion electrochemical cell 100, in accordance with some examples. Specifically, the lithium-ion electrochemical cell 100 comprises a negative battery electrode 110, a positive electrode 102, and an electrolyte 104. Other components (not shown in FIG. 2A) may include a separator, case, electrode/cell tabs, and the like. The negative battery electrode 110 and positive electrode 102 (together with the separator) may be arranged in a stack, wound jelly roll, or any form. Specifically, the separator may be disposed between the negative battery electrode 110 and positive electrode 102 to prevent direct contact between the electrodes yet allow ionic communication between these electrodes. Specifically, the separator may include pores, which are soaked with the electrolyte 104 that allows ions to pass between the electrodes. In other words, the electrolyte 104 operates as a carrier of ions during the cycling of the lithium-ion electrochemical cell 100. Some examples of separator material include poly(ethylene-co-tetrafluoroethylene (PETFE), poly(ethylenechloro-co-trifluoroethylene), polystyrenes, polyvinyl chlorides polypropylene, polyethylene, polyamides, polyimides, polyacrylics, polyacetals, polycarbonates, polyesters, polyetherimides, polyimides, polyketones, polyphenylene ethers, polyphenylene sulfides, glass fiber materials, ceramics, and a polypropylene membrane.

The electrolyte 104 may be liquid, solid, or gel. A liquid electrolyte may include one or more solvents and one or more lithium-containing salts. Some solvent examples include cyclic carbonates (e.g., ethylene carbonate (EC), propylene carbonate (PC), butylene carbonate (BC) and vinylethylene carbonate (VEC)), lactones (e.g., gamma-butyrolactone (GBL), gamma-valerolactone (GVL) and alpha-angelica lactone (AGL)), linear carbonates (e.g., dimethyl carbonate (DMC), methyl ethyl carbonate (MEC), diethyl carbonate (DEC), methyl propyl carbonate (MPC), dipropyl carbonate (DPC), methyl butyl carbonate (NBC) and dibutyl carbonate (DBC)), ethers (e.g., tetrahydrofuran (THF), 2-methyltetrahydrofuran, 1,4-dioxane, 1,2-dimethoxyethane (DME), 1,2-diethoxyethane and 1,2-dibutoxyethane), nitriles (e.g., acetonitrile and adiponitrile) linear esters (e.g., methyl propionate, methyl pivalate, butyl pivalate and octyl pivalate), and amides (e.g., dimethyl formamide). Some examples of salts include LiPF₆, LiBF₄, LiClO₄ LiAsF₆, LiN(CF₃SO₂)₂, LiN(C₂F₅SO₂)₂, LiCF₃SO₃, LiC(CF₃SO₂)₃, LiPF₄ (CF₃)₂, LiPF₃ (C₂F₅)₃, LiPF₃ (CF₃)₃, LiPF₃ (iso-C₃F₇)₃, LiPF₅(iso-C₃F₇), lithium salts having cyclic alkyl groups (e.g., (CF₂)₂ (SO₂)_{2X}Li and (CF₂)₃ (SO₂)_{2X}Li), and combination of thereof. The total concentration of one or more salts in the electrolyte is at least about 0.3 M or, more specifically, at least about 0.7M.

FIG. 2B is a schematic illustration of a negative battery electrode 110, in accordance with some examples. The negative battery electrode 110 comprises a negative-electrode negative-electrode current collector 114 and one or two negative active material layers 112, supported by the negative-electrode current collector 114. The negative-electrode current collector 114 provides electric communication between the negative active material layers 112 and other components of a lithium-ion electrochemical cell 100 (e.g., cell tabs). While FIG. 2B illustrates two negative active material layers 112, one having ordinary skill in the art would understand that an example with one negative active material layer 112 is also within the scope. This example may be referred to as a one-sided negative battery electrode. Various examples of the negative-electrode current collector 114 are within the scope, such as copper and/or copper dendrite-coated metal oxides, stainless steel, titanium, aluminum, nickel, chromium, tungsten, metal nitrides, metal carbides, carbon, carbon fiber, graphite, graphene, carbon mesh, conductive polymers, or combinations of above including multi-layer and/or composite structures. The negative-electrode current collector 114 may be formed as a foil, films, mesh, metallic foam laminate, wires, tubes, particles, multi-layer structure, or any other suitable configurations. In one example, the negative-electrode current collector 114 is a stainless steel foil having a thickness of between about 1 micrometer and 50 micrometers. In other examples, the negative-electrode current collector 114 is a copper foil with a thickness of between about 5 micrometers and 30 micrometers. In yet another example, current collector 114 is an aluminum foil with a thickness of between about 5 micrometers and 50 micrometers. It should be noted that the material of the negative-electrode current collector 114 used in the negative battery electrode 110 should be stable for potential ranges experienced by the negative battery electrode 110.

The positive electrode 102 may include a positive active material arranged into one or more positive active material layers. Some examples of positive active materials include Li(M′_{X}M″_{Y})O₂, where M′ and M″ are different metals (e.g., Li(Ni_{X}Mn_{Y})O₂, Li(Ni_{1/2}Mn_{1/2})O₂, Li(Cr_{X}Mn_{1-X})O₂, Li(Al_{X}Mn_{1-X})O₂), Li(Co_{X}M_{1-X})O₂, where M is a metal, (e.g., Li(Co_{X}Ni_{1-X})O₂ and Li(Co_{X}Fe_{1-X})O₂), Li_{1-W}(Mn_{X}Ni_{Y}Co_{Z})O₂, (e.g., Li(Co_{X}Mn_{Y}Ni_{(1-x-Y)}O₂, Li(Mn_{1/3}Ni_{1/3}Co_{1/3})O₂, Li(Mn_{1/3}Ni_{1/3}Co_{1/3}-XMgₓ)O₂, Li(Mn_{0.4}Ni_{0.4}Co_{0.2})O₂, Li(Mn_{0.1}Ni_{0.1}Co_{0.8})O₂,) Li_{1-W}(MnₓNi_{X}Co_{1-2X})O₂, Li_{1-W}(MnₓNi_{X}CoAl_{W})O₂, Li_{1-W}(Ni_{X}Co_{X}Al_{Z})O₂ (e.g., Li(Ni_{0.8}Co_{0.15}Al_{0.05})O₂), Li_{1-W}(Ni_{X}Co_{Y}M_{Z})O₂, where M is a metal, Li_{1-W}(Ni_{X}Mn_{Y}M_{Z})O₂, where M is a metal, Li(Ni_{X-Y}Mn_{Y}Cr₂₋ₓ)O₄, LiM′M″₂O₄, where M′ and M″ are different metals (e.g., LiMn_{2-Y-Z}Ni_{Y}O₄, LiMn_{2-Y-Z}Ni_{Y}Li_{Z}O₄, LiMn_{1.5}Ni_{0.5}O₄, LiNiCuO₄, LiMn₁₋ₓAlₓO₄, LiNi_{0.5} Ti_{0.5}O₄, Li_{1.05}Al_{0.1}Mn_{1.85}O_{4-z}F_{z}, Li₂ MnO₃) Li_{X}V_{Y}O_{Z}, e.g., LiV₃O₈, LiV₂O₅, and LiV₆O₁₃.

Examples of Active-Material Structures with Dispersed Inert Elements

Referring to FIG. 2A, electrochemically active-material structures 120 comprise silicon 130 and one or more inert elements 140, dispersed in the electrochemically active-material structures 120. The inert element 140 comprises one or more elements selected from the group of hydrogen (H), lithium (Li), boron (B), carbon (C), nitrogen (N), fluorine (F), sodium (Na), magnesium (Mg), aluminum (Al), phosphorous (P), sulfur(S), chlorine (Cl), potassium (K), calcium (Ca), scandium (Sc), titanium (Ti), vanadium (V), chromium (Cr), manganese (Mn), iron (Fe), cobalt (Co), nickel (Ni), copper (Cu), zinc (Zn), gallium (Ga), bromine (Br), strontium (Sr), zirconium (Zr), niobium (Nb), molybdenum (Mo), indium (In), lanthanum (La), cerium (Ce), tantalum (Ta), tungsten (W), and bismuth (Bi). For purposes of this disclosure, the term “inert element 140” is defined as an element not interacting with lithium at an operating voltage of the negative battery electrode 110 such that the inert element 140 does not contribute to the overall capacity of the electrochemically active-material structures 120. In other words, the lithiation capacity of the electrochemically active-material structures 120 is provided entirely by the content of silicon 130 in the electrochemically active-material structures 120.

In some examples, a specific subset of inert element examples includes hydrogen (H), boron (B), carbon (C), nitrogen (N), fluorine (F), magnesium (Mg), aluminum (Al), chlorine (Cl), titanium (Ti), chromium (Cr), iron (Fe), gallium (Ga), and bromine (Br). These specific materials have fewer viable oxidation states in the operating voltage window of the negative battery electrode 110 (than other examples not included in this list), which enhances their stability and reduces the capacity losses in the battery. Furthermore, this subset can be narrowed to hydrogen (H), boron (B), carbon (C), nitrogen (N), fluorine (F), magnesium (Mg), aluminum (Al), chlorine (Cl), iron (Fe), and bromine (Br), which are lighter elements thereby ensuring higher gravimetric capacity. Even a more specific subset includes hydrogen (H), carbon (C), nitrogen (N), fluorine (F), aluminum (Al), chlorine (Cl), iron (Fe), and bromine (Br). These materials are less basic when contacting water thereby allowing to use of these materials in water-base slurries.

In some examples, the inert element 140 comprises one or more elements selected from the group of hydrogen (H), carbon (C), nitrogen (N), and chlorine (Cl). Specifically, hydrogen (H) is the lightest element, which allows achieving the inter-function without introducing too much energy density and/or capacity loss. Hydrogen (H) can be co-synthesized with silicon (Si) using the following precursors: inorganic acid, organic acid, ammonium salts, silane, chrolosilane, or organosilane, e.g. sulfuric acid (H₂SO₄), nitric acid (HNO₃), acetic acid (CH3COOH), citric acid (HOC(Co₂H)(CH₂CO₂H)₂), hydrochloric acid (HCl), hydrobromic acid (HBr), ammonium floride (NH₄F), ammonium chloride (NH₄Cl), monosilane (SiH₄), dililane (Si2H₆), tricholosilane (HSiCl₃), dichlorosilane (H₂SiCl₂), dimethylsilane (H₂Si(CH₃)₂), phenylsilane (C₆H₅SiH₃). One example of incorporating hydrogen (H) into silicon structures includes proton reduction to zero-valent hydrogen and dissolving in the newly formed silicon, e.g., (a) H⁺+e⁻=>H⁰ and (b) xH⁰+Si=>Si(H)ₓ. Another example involves incomplete dissociation of H—Si bonds, e.g., C₆H₅SiH₃=>C₆H₆+Si(H)ₓ+(2−x)/2H₂.

In some examples, the concentration (atomic percentage) of hydrogen (H) in the electrochemically active-material structures 120 is 0-75% such as 10 ppm-50%, 10 ppm-25%, 10 ppm-20%, 10 ppm-10%, 10 ppm-5%, 10 ppm-2%, 10 ppm-1%, 10 ppm-1000 ppm, and 10 ppm-100 ppm.

Carbon (C) is a light element and can be conductive. It should be noted that silicon is not bound to carbon in the non-conductive form (i.e., does not form crystalline silicon carbide).

Furthermore, the chemical dispersion is different from silicon and carbon mixtures (e.g., when silicon and carbon are parts of different structures combined together as silicon particles and carbon particles). Various examples of carbon (C) being co-synthesized with silicon (Si) are described below. In some examples, the concentration (atomic percentage) of carbon (C) in the electrochemically active-material structures 120 is 0-75%, 0.01-50%, 0.01-25%, 0.01-20%, 0.01-10%, 0.01-5%, 0.01-2%, 0.01-1%, 0.1-30%, 1-30%, 5-30%, 5-20%, or 5-15%.

Similar to hydrogen (H), nitrogen (N) is a light element, which increases the hardness of silicon thereby mitigating the mechanical stresses induced on silicon during its lithiation. Nitrogen (N) can be co-synthesized with silicon (Si) using the following precursors and reactions: hexamethyldisilazane (C₆H₁₉NSi₂) and 2,2,4,4,6,6-hexamethylcyclotrisilazane. In some examples, the concentration (atomic percentage) of nitrogen (N) in the electrochemically active-material structures 120 is 0-75%, 0.01-50%, 0.01-25%, 0.01-20%, 0.01-10%, 0.01-5%, 0.01-2%, 0.01-1%, 0.1-30%, 1-30%, 5-30%, 5-20%, or 5-15%.

Chlorine (Cl) is a negatively charged anion that stabilizes the overall structure of the electrochemically active-material structures 120. Chlorine (Cl) can be co-synthesized with silicon (Si) using the following precursors and reactions: silicon tetrachloride (SiCl₄), Hexachlorodisilane (Si2Cl6), trichlorosilane (HSiCl₃), dicholorosilane (H₂SiCl₂), dimethyldichlorosilane (CH₃)₂SiCl₂, methyltrichlorosilane (CH₃) SiCl₃, chlorine (Cl₂), acyl chlorides, metal chlorides, quaternary ammonium compounds. In some examples, the concentration of chlorine (Cl) in the electrochemically active-material structures 120 is 0-75%, 0.01-50%, 0.01-25%, 0.01-20%, 0.01-10%, 0.01-5%, 0.01-2%, 0.01-1%, 0.1-30%, 0.1-10%, 1-10%, 2-10%, 2-5%, or 1-5%.

In general, the inert element 140 may have a concentration of 30-50% atomic in the electrochemically active-material structures 120, in which case, the electrochemically active-material structures 120 may be referred to as a high inert material content. At such high concentration levels of the inert element 140, the electrochemically active-material structures 120 can be highly stable but have reduced gravimetric lithiation capacity. In other examples, the inert element 140 may have a concentration of 5-30% atomic in the electrochemically active-material structures 120, which may be referred to as a moderate inert material content with a balanced performance. In further examples, In general, the inert element 140 may have a concentration of 0.1-5% atomic in the electrochemically active-material structures 120, which may be referred to as low inert material content-such structures retain their higher capacity at the expense of the mechanical stabilization.

In some examples, the electrochemically active-material structures 120 further comprise oxygen (in addition to the inert element 140). The oxygen atoms form one of the strongest bonds with silicon (bond energy of Si—O=798 KJ/mol) than Si—Si(bond energy of Si—Si=327 KJ/mol) or Si—Li (estimated to be 188 KJ/mol). Therefore, a very strong stabilizing effect can be achieved during lithiation. The concentration (atomic percentage) of oxygen in the electrochemically active-material structures 120 may be 5-30%, 0.1-5%.

In some examples, the inert element 140 and the silicon 130 form one or more of a homogenous mixture, a solid solution, and an alloy in the electrochemically active-material structures 120.

In some examples, while chemically dispersed with the inert element 140, the active-material structures 120 still preserve an amorphous silicon or polycrystalline silicon structure. This silicon structure with the amorphous or polycrystalline nature of the active-material structures 120 can be characterized by Raman spectroscopy. Raman spectroscopy reflects the vibrational modes of the molecules which can provide structural fingerprints of materials. This can help to differentiate the active-material structures 120 from silicon monoxide or silicon carbide. In some examples, the active-material structures 120 with amorphous silicon structure will present a broad peak with Raman shift at around 460 cm⁻¹ (e.g., 450-470 cm⁻¹). In other examples, the active-material structures with polycrystalline structure will present a sharp peak with Raman shift at around 520 cm⁻¹ (e.g., 515-525 cm⁻¹). This is distinctly different from silicon monoxide (SiO) which presents three main peaks at 444 cm⁻¹, 454 cm⁻¹, and 502 cm⁻¹. This is also distinctly different from SiC which has three peaks at around 760 cm⁻¹, 790 cm⁻¹, and 960 cm⁻¹.

In some examples, the amorphous or polycrystalline silicon nature of the active-material structures 120 can be characterized by X-ray diffraction. The diffraction patterns of amorphous material feature broad peaks rather than sharp peaks in crystalline materials. In the example of amorphous silicon, two broad peaks at around 26 degrees and 50 degrees will be found, while the three most intensive peaks for crystalline silicon can be found as sharp peaks at around 28.5 degrees, 47.3 degrees, and 56.1 degrees, respectively. To be noted, either the amorphous or polycrystalline state of the active-material structures 120 is still preserving the silicon as the base crystal structure (e.g., amorphous or polycrystalline). This is distinguishable from silicon carbide (SiC), silicon suboxide such as silicon monoxide (SiO), or silicon dioxide (SiO₂), which can't be heat treated to get pure crystalline Silicon structure without other reducing agents.

While the above description focuses on silicon 130, other high-capacity materials are also within the scope. Some other examples of high-capacity materials include, but are not limited to, silicon oxide, tin, tin oxides, germanium, and silicide. For example, silicon has a theoretical lithiation capacity of 3,579 mA/g and swells to about 3.8 times its initial volume at this lithiation limit. Germanium has a theoretical lithiation capacity of 1600 mA/g and swells about 3.5 times. Tin has a theoretical lithiation capacity of 994 mA/g and swells about 2.6 times. As a reference, graphite has a theoretical lithiation capacity of 372 mA/g and is an example of a low-capacity material. As noted above, as a result of these large capacities, high-capacity materials tend to experience large volume changes.

Referring to FIG. 2B, electrochemically active-material structures 120 are predominantly disjoined structures. The disjoined structures are defined as any two structures in which the high-capacity material of one structure does not physically contact the high-capacity material of the other structure or at least minor contact prevents any direct lithium migration between the two structures. It should be noted that other components of these disjoined structures (e.g., SEI layers) can contact each other and even overlap. For example, a disjoint ratio of electrochemically active-material structures 120 is at least 70%, at least 80%, or even at least 90%. The “disjoint ratio” is defined as a ratio of the number of all disjoint structures to the number of all (disjoint and fused) structures in a negative battery electrode.

In some examples, electrochemically active-material structures 120 are uniformly distributed within negative battery electrode 110 or, more specifically, within negative active material layer 112. The uniform distribution is defined as the difference in the volume, occupied by the electrochemically active-material structures in two disjoined unit volumes being less than 20%, less than 10%, or even less than 5%. The uniform distribution helps to prevent lithium welding/joining of electrochemically active-material structures 120 during cycling of the lithium-ion electrochemical cell that this negative battery electrode 110 is a part of.

In some examples, the negative active material layer 112 has a specific porosity defined as a ratio of the volume of all void spaces in the negative active material to the volume of the electrochemically active-material structures (SP=V_{VOIDS}/V_{EAMS}). The specific porosity (SP) should be distinguished from conventional porosity, where the basis would be the total volume of negative active material layer 112. In some examples, the specific porosity (SP) of the negative active material layer is at least 200% or, more specifically at least 300% or even at least 500%. The specific porosity (SP) provides a direct reference as to how much space is available in the negative active material layer 112 for electrochemically active-material structures 120 to swell into. The sufficient amount of space prevents electrochemically active-material structures 120 from pushing on each other and potentially causing these particles to join together/fuse (and potentially exceeding the pulverization threshold).

In some examples, negative battery electrode 110 further comprises additional structures that are configured to experience substantially no volume change during the cycling of the lithium-ion electrochemical cell. More specifically, the relative positions of electrochemically active-material structures 120 and additional structures remain the same during the cycling of the lithium-ion electrochemical cell. Some examples of additional structures include, but are not limited to, conductive-additive structures, stabilizing structures, and binders. For example, conductive-additive structures can be formed from a material selected from the group consisting of graphite, acetylene black, metal silicides, metal oxides, and silicates. Some examples of binders include, but are not limited to, arboxymethyl cellulose (CMC), styrene-butadiene rubber (SBR), polyacrylic acid (PAA), polyimides (PI), and poly(3,4-ethylenedioxythiophene) polystyrene sulfonate (PEDOT:PSS). The concentration of polymer binder in the negative active material layer 112 may be less than 20% by weight or even less than 1% by weight. These additional structures should be distinguished from the inert elements 140, which are parts of the electrochemically active-material structures 120.

### Examples of Methods of Fabricating Electrochemically Active-Material Structures

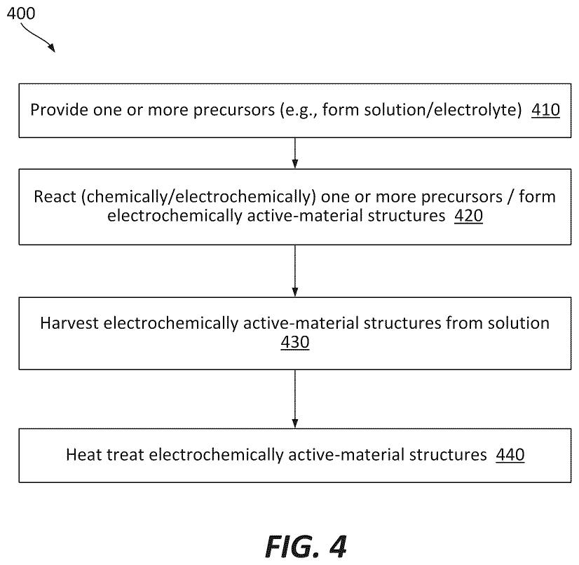

FIG. 4 is a process flowchart corresponding to method 400 of fabricating electrochemically active-material structures 120 for a negative battery electrode 110 for use in a lithium-ion electrochemical cell 100, in accordance with some examples. Various examples of these electrochemically active-material structures 120 and negative battery electrodes 110 as well as lithium-ion electrochemical cells 100 are described above. Additional features will be now described in the context of this structure's fabrication method 400.

In some examples, method 400 commences with (block 410) providing one or more precursors comprising silicon 130 and one or more inert elements 140. These precursors are dissolved in a liquid solvent and form a homogenous liquid-phase mixture. More specifically, one or more precursors are atomically dispersed in one or more precursors (due to the dissolution of the precursors in the liquid solvent). This dissolution/atomic dispersion resulting in the homogenous nature of the liquid-phase mixture ensures that the silicon 130 and one or more inert elements 140 are chemically dispersed in the electrochemically active-material structures 120 when these electrochemically active-material structures 120 are formed. In other words, the atomic dispersion in the of the liquid-phase mixture and simultaneous extraction ensure the chemical dispersion and, in some examples, the atomic dispersion in the electrochemically active-material structures 120.

In some examples, the homogenous liquid-phase mixture may be substantially free from solid species (e.g., solid particles) before reacting the one or more precursors (e.g., the solid-phase content may be less than 5% by weight, less than 1% by weight, or even less than 0.1% by weight). Particles or, more specifically, electrochemically active-material structures 120 are formed when one or more precursors react.

Method 400 may proceed with (block 420) reacting one or more precursors to form the electrochemically active-material structures 120 comprising the silicon 130 and the inert element 140, dispersed in the electrochemically active-material structures 120. Specifically, one or more precursors can react chemically or electrochemically. In some examples, these reactions may be performed at a temperature less than 300° C. or even less than 100° C.

In other words, one or more precursors are reacted using reaction conditions that induce the formation of the electrochemically active-material structures 120 by simultaneously extracting the silicon 130 and the one or more inert elements 140 from the one or more precursors and incorporating the silicon 130 and the one or more inert elements 140 into the electrochemically active-material structures 120.

It should be noted that the electrochemically active-material structures 120 are solid structures forming a suspension in the liquid solvent. This suspension should be distinguished from the homogenous liquid-phase mixture that exists before the electrochemically active-material structures 120 are formed. In other words, the homogenous liquid-phase mixture is converted into a suspension as the electrochemically active-material structures 120 are formed from one or more precursors.

In some examples, the reaction conditions comprise introducing a reducing agent having a reducing potential more negative than any of the one or more precursors dissolved in the liquid solvent. For example, the reducing agent has a reducing potential more negative than −1V vs. a standard hydrogen electrode. Various examples of reducing agents are described below.

In some examples, the liquid solvent forming the homogenous liquid-phase mixture is selected from the group consisting of an organic solvent and an ionic liquid. For example, the liquid solvent is the organic solvent selected from the group consisting of an alkane, alkene, arene, ether, halogenated solvent, ester, amide, nitrile, and carbonate.

In some examples, method 400 further comprises (block 430) harvesting the electrochemically active-material structures 120 from the solution and (block 440) heat treating the electrochemically active-material structures 120. For example, the electrochemically active-material structures 120 can settle at the bottom of the reaction tank due to gravity and can be collected and washed (e.g., to remove residual precursors, and solvents) and dried.

In some examples, the heat treatment is performed at a temperature of 50-1100° C. (e.g., 200-400° C., 400-600° C., 600-800° C., or 800-1100° C.) to crystalize the electrochemically active-material structures 120. For example, the crystallization degree can be defined by crystallization enthalpy (at around 800° C.), with the crystallinity degree being less than 90%, less than 50%, less than 20%, or even less than 5% in some examples.

### Electrochemical Fabrication Examples

For example, the electrochemical fabrication may utilize two electrodes submerged into an electroplating bath that can be used for containing one or more precursors. A voltage of between 2.5V to 6V or, more specifically, between 3V and 5V can be applied between these electrodes to initiate the electrochemical reactions.

For example, an electrochemical reduction can be performed in an electrolyte solution comprising a solvent, a salt, and one or more precursors. In a specific example, 1 M of silicon tetrachloride (SiCl₄), 1M of carbon tetrachloride (CCl₄), and 1M of tetrabutylammonium chloride ((C₄H₉)₄NCl) can be dissolved in diglyme to form the electrolyte solution. A voltage of 5V can be applied between the electrodes submerged in this solution. The product can be harvested as electrochemically active-material structures containing chemically dispersed silicon and carbon.

$${x SiCl}_{4} + {y CCl}_{4} \text{=>} Si x ( C ) y + 2 ( x + y ) {Cl}_{2}$$

The amount of carbon integrated into electrochemically active-material structures 120 is expected to be 1 to 30 atomic %.

The voltage applied here can far exceed the deposition voltage needed for these two precursors. Therefore, the reaction rate can exceed the speed of the formed product to be selectively deposited.

### Chemical Fabrication Examples

In a chemical reduction example, one or more precursors are mixed with one or more reductive agents for reaction. In more specific examples, a solvent can be optionally added to the mixture to facilitate the reaction between one or more precursors and one or more reductive agents. Suitable reducing agents have a redox potential below-1V vs. the standard hydrogen electrode and may include lithium metal, sodium metal, magnesium metal, lithium biphenyl, sodium naphthalene, and the like. Examples of liquid solvents include alkanes, alkenes, arenes, ethers, halogenated solvents, esters, amides, nitriles, carbonates, ionic liquids, and the like It should be noted that the reaction takes place at a temperature not exceeding 300° C., not exceeding 200° C., or not exceeding 100° C., or even at not exceeding 50° C.

In a specific example, 1M of Li metal (used as a reductive agent) can be dissolved in 2M of lithium biphenyl solution in tetrahydrofuran (THF) (used as a solvent), forming a homogenous liquid mixture. 0.125M of trichloromethylsilane (CH₃—SiCl₃) (used as both a carbon-containing precursor and a silicon-containing precursor) and 0.125M of silicon tetrabromide (SiBr₄) (used as a silicon-containing precursor) can be added into the solution to induce the reduction of these two precursors. The reaction takes place at room temperature and can initiate immediately upon the addition of the two precursors. The ratio of carbon doping can be tuned by the ratio between the two precursors, i.e., trichloromethylsilane (CH₃—SiCl₃) and silicon tetrabromide (SiBr₄)). For example, the 0.125M of trichloromethyl silane (CH₃—SiCl₃) and 0.125M of silicon tetrabromide (SiBr₄) produce the final C:Si atomic ratio is 1:2. The corresponding chemical reaction is presented below:

$$7 Li - metal + {CH}_{3} - {SiCl}_{3} + {SiBr}_{4} \text{=>} {{Si}_{2} ( {CH}_{3} )}_{x} + 3 LiCl + 4 LiBr + ( 1 - x ) {C}_{2} {H}_{6}$$

### Single-Precursor Examples

In some examples, one or more precursors comprise a single precursor comprising both silicon 130 and the inert element 140. Some examples of such single precursors an organosilane, silazane, silylacetamides, and organochlorosilane. A single precursor is mixed with another reagent (e.g., reducing reagents such as lithium metal). Specific examples of organosilanes include trichlorosilane, trichloromethylsilane (SiHCl3), trichloroethylsilane, (SiCH3Cl3), trichlorophenylsilane (Si(C₂H₅)Cl3), and dichlorodimethylsilane (Si(CH₃)2Cl2), and chloro (dimethyl)phenylsilane. An example of the reaction is presented below.

$$Si ( {C}_{2} {H}_{5} ) {Cl}_{3} = Li \text{=>} {SiCl}_{x} {C}_{y} {H}_{z} + ( 3 - x ) LiCl + ( 2 - y ) / 2 {C}_{2} {H}_{4} + ( 1 - z + 2 y ) / 2 {H}_{2}$$

Specific examples of silazanes include hexamethyldisilazane (C₆H₁₉NSi₂) and 2,2,4,4,6,6-hexamethylcyclotrisilazane, N-Trimethylsilylacetamide, and N-(Trimethylsilyl)dimethylamine. An example of the reaction is presented below.

$${{C}_{6} {H}_{19} {NSi}_{2} \text{=>} 2 Si ( N )}_{x} + 3 {C}_{2} {H}_{6} + ( 1 - 2 x ) / 2 {N}_{2} + 1 / 2 {H}_{2}$$

### Multiple-Precursor Examples

Alternatively, one or more precursors comprise a first precursor comprising the silicon 130 and a second precursor comprising the inert element 140, the second precursor having a different composition than the first precursor.

For example, a silicon-generating precursor can be selected from the group consisting of silicon tetrachloride (SiCl₄), di-silicon hexachloride (Si₂Cl₆), silicon tetrabromide (SiBr₄), silicon tetraiodide (SiI₄), silane (SiH₄), di-silane (Si₂H₆), and tri-silane (Si₃H₈).

$${SiCl}_{4} = > Si ( solid ) + 2 {Cl}_{2} ( gas )$$

In the same or other examples, a carbon-generating precursor can be selected from the group consisting of cholorobenzene (C₆H₅Cl), dicholorbenze (C₆H₄Cl₂), trichlorobenze (C₆H₃Cl₃), hexacholorbenzene (C₆Cl₆), dibromobenzene (C₆H₄Br₂), chloromethane (CH₃Cl), dicholoromethane (CH₂Cl₂), trichloromethane (CHCl₃), tetrachloro carbon (C₂Cl₄), and tetrabromo carbon (CBr₄).

For example, the precursors can comprise both silicon tetrachloride (SiCl₄) and carbon tetrachloride (CCl₄), provided in a solvent and forming an electrolyte. The electrochemical reaction can be initiated by applying a voltage of 2.5-6V between the two electrodes submerged in the electrolyte, triggering the following reactions:

$$\begin{matrix}{SiCl}_{4} \text{=>} Si ( solid ) + 2 {Cl}_{2} ( gas ) \\ {CCl}_{4} \text{=>} C ( solid ) + 2 {Cl}_{2} ( gas )\end{matrix}$$

Since silicon (Si-solid) and carbon (C-solid) are produced at the same time in the same solution, the electrochemically active-material structures 120 have both silicon and carbon chemically dispersed.

In some examples, one or more precursors comprise a halide selected from the group consisting of a metal halide, a non-metal halide, an amine, and an amide. For example, the metal halide is selected from the group consisting of titanium tetrachloride (TiCl₄), iron (III) chloride (FeCl₃), aluminum chloride (AlCl₃), and magnesium chloride (MgCl₂). The non-metal halide is selected from the group consisting of phosphorus trichloride (PCl₃), phosphorus pentachloride (PCl₅), boron trichloride (BCl₃). The amine is selected from the group consisting of trimethylamine ((CH₃)₃N) and melamine (C₃H₅N₆). The amide can be dimethylformamide (C₃H₇NO).

$$\begin{matrix}{SiCl}_{4} \text{=>} Si ( solid ) + 2 {Cl}_{2} ( gas ) \\ {TiCl}_{4} \text{=>} Ti ( solid ) + 2 {Cl}_{2} ( gas )\end{matrix}$$

Since silicon (Si-solid) and titanium (Ti-solid) are produced at the same time in the same solution, the formed electrochemically active-material structures comprise chemically dispersed silicon and titanium.

In some examples, one or more precursors comprise one or more oxygen-generating precursors selected from the group consisting of water (H₂O), dissolved oxygen, carbon dioxide (Co₂), oxygen-containing organics, such as alcohol (e.g., ethanol (CH₃CH₂OH)), an oxalate salt (e.g., ammonium oxalate ((NH₄)₂C₂O₄), organic acids, and a nitrate salt (e.g., ammonium nitrate (NH₄NO₃)). In these examples, the electrochemically active-material structures 120 further comprise oxygen and/or carbon.

In specific, silicon tetrachloride (SiCl₄) can chemically react with ethanol (CH₃CH₂OH) resulting in oxygen and/or carbon produced and trapped inside silicon structures:

SiCl₄+4CH₃CH₂OH=>Si(CH₃CH₂O)₄+HCl (solution)

Si(CH₃CH₂O)₄=>Si (with dispersed O,C)+CH₄/CO/H₂O (thermal decompose)

Specifically, silicon tetrachloride (SiCl₄) can electrochemically be reduced to silicon while nitrate salt can continuously chemically react with the nascent silicon surface to induce oxygen inside silicon structures:

$$\begin{matrix}{SiCl}_{4} = > Si + {Cl}_{2} ( electrolysis ) \\ Si + {x NO}_{3}^{-} = {SiO}_{x} + {x NO}_{2}^{-}\end{matrix}$$

Alternatively, the nitrate can also be electrochemically reduced to release oxygen into the silicon structure.

$${SiCl}_{4} + {x NO}_{3}^{-} = > {SiO}_{x} + {x NO}_{2}^{-} + 2 {Cl}_{2} ( electrolysis )$$

In another example, the precursors comprise both trichlorosilane (HSiCl₃) and lithium chloride (LiCl), forming an electrolyte together with a solvent. A voltage of 3.5-4.5V can be used between two electrodes triggering the following reactions:

$$\begin{matrix}{HSiCl}_{4} \text{=>} Si ( solid ) + 3 / 2 {Cl}_{2} + HCl ( electrolysis ) \\ LiCl \text{=>} Li ( solid ) + 2 {Cl}_{2} ( electrolysis )\end{matrix}$$

In a similar example, the precursors comprise silicon tetrachloride (SiCl₄) and lithium chloride (LiCl) to form the electrolyte. A voltage of 3.5-4.5V can be used between two electrodes triggering the following reactions:

$$\begin{matrix}LiCl = > Li ( solid ) + 1 / 2 {Cl}_{2} ( electrolysis ) \\ {SiCl}_{4} = > Si ( solid ) + 2 {Cl}_{2} ( electrolysis )\end{matrix}$$

### Experimental Results

Various experiments have been conducted to compare the performance of conventional silicon-based lithium-ion electrochemical cells and similar cells in which electrochemically active-material structures comprising both silicon and inert elements, are dispersed within the electrochemically active-material structures. Specifically, in these conventional cells, the electrochemically active-material structures consisted essentially of silicon (e.g., the composition of silicon was greater than 99%). For simplicity, such cells can be referred to as pure-silicon cells. The silicon-only cells can further be physically mixed with conductive carbon and surface coated by a carbon layer. The cells in which both silicon and inert elements were present in the electrochemically active-material structures can be referred to as dispersed-structures cells.

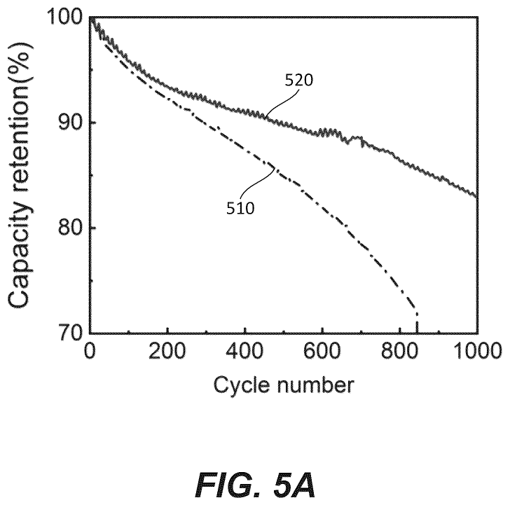

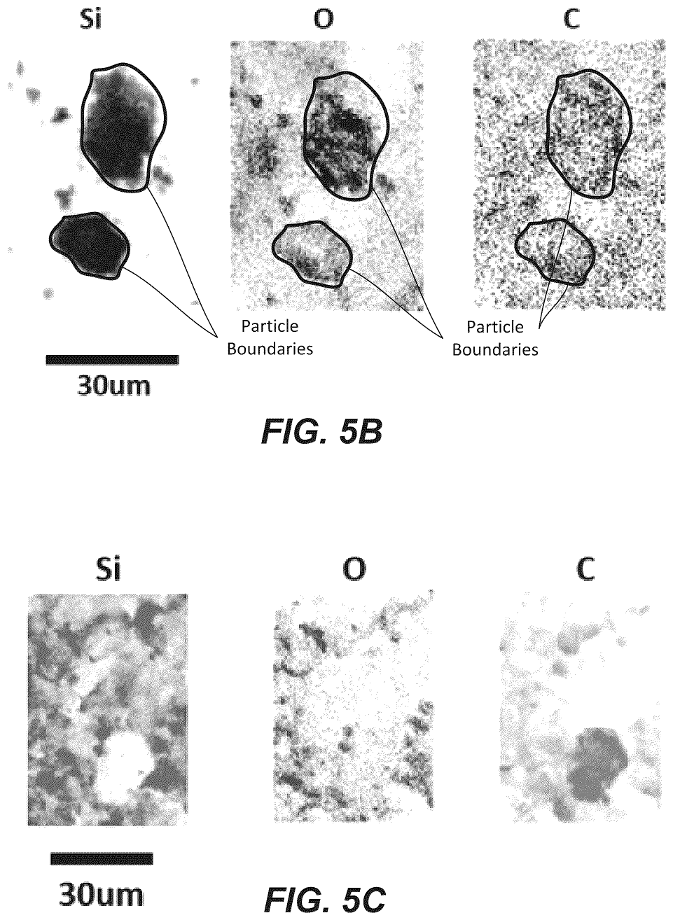

FIG. 5A illustrates the cycle-life profiles of two cells (1) line 510 represents the cycling data for cells fabricated with pure silicon physically mixed with carbon materials and further coated by carbon coating on the surface (dash-dot line), (2) line 520 represents the cycling data for cells fabricated with electrochemically active-material structures containing chemically dispersed silicon and carbon and oxygen from the synthesis process, which has chemically mixed Si, C and O inside the material (solid line). The two materials were mixed separately with the same graphite material to form anode slurries with a gravimetric capacity of 450 mAh/g. Corresponding full cells were made with NMC622 cathodes and EC/DEC with 1M LiPF₆ electrolyte. The full cells were cycled between 4.2V to 2.8V for capacity retention evaluation. The dispersed-structures cells (line 520) exceeded the performance of pure silicon cells (line 510) which have already been improved by the carbon physical mixing and surface coating. At the 1000th cycle, the dispersed-structures cells still retained (line 520) more than 80% of their initial capacity while the pure-silicon cells dropped below 80% retention at around the 650th cycle.

FIGS. 5B and 5C illustrate the difference in energy-dispersive spectroscopy (EDS) mapping analysis of individual silicon (Si), oxygen (O), and carbon (C) elements in electrochemically active-material structures synthesized such that these elements are chemically dispersed (FIG. 5B) and physical mixture of pure silicon mixed with carbon (FIG. 5C). Dark colors indicate the presence of certain elements in that area. For the chemically dispersed elements, the intensity of silicon (Si), oxygen (O), and carbon (C) aligned well with the shape of the particles. The particle boundaries are identified with lines in all three EDS images (in FIG. 5B) and are the same for all three elements. This indicates that both particles identified in these three EDS images contain silicon (Si), oxygen (O), and carbon (C) elements, i.e., that these elements do not form individual particles with their own defined boundaries.

However, the EDS images of the physical mixture of pure silicon mixed with carbon (in FIG. 5C) show more carbon (C) intensity in the carbon-rich region and more silicon (Si) intensity in the Si-rich region. As such, carbon (C) and silicon (Si) are present in different types of particles (e.g., carbon particles that are free from silicon and silicon particles that are free from carbon). The change of volume expansion of the materials was examined by the swelling ratio test. Both slurries were assembled into half-cell configurations with lithium (Li) and counter/reference electrodes. The full lithiation state was achieved by discharging both half cells to 10 mV vs Li⁺/Li. The welling ratio of doped silicon is around 34% at the electrode level when fully lithiated while the pure silicon cells are around 48%.

### CONCLUSION

Although the foregoing concepts have been described in some detail for purposes of clarity of understanding, it will be apparent that certain changes and modifications may be practiced within the scope of the appended claims. It should be noted that there are many alternative ways of implementing the processes, systems, and apparatuses. Accordingly, the present examples are to be considered illustrative and not restrictive.

1. A method of fabricating electrochemically active-material structures, for negative battery electrodes in lithium-ion electrochemical cells, using a homogenous liquid-phase mixture, the method comprising:
providing one or more precursors dissolved in a liquid solvent and forming the homogenous liquid-phase mixture in which one or more precursors are atomically dispersed, wherein the one or more precursors comprise silicon, carbon, oxygen, and one or more inert elements; and
reacting the one or more precursors using reaction conditions that induce formation of the electrochemically active-material structures by simultaneously extracting the silicon and the one or more inert elements from the one or more precursors and incorporating the silicon and the one or more inert elements into the electrochemically active-material structures, wherein:
the silicon and the one or more inert elements are chemically dispersed in the electrochemically active-material structures,
the electrochemically active-material structures are solid structures forming a suspension in the liquid solvent,
the electrochemically active-material structures are characterized by an amorphous silicon phase or a polycrystalline silicon phase while comprising the one or more inert elements in addition to the silicon, and
the reaction conditions induce one or both of a chemical reaction and a electrochemical reaction of the one or more precursors.

2. The method of claim 1, wherein the one or more inert elements are selected from the group consisting of hydrogen (H), nitrogen (N), magnesium (Mg), fluorine (F), chlorine (Cl), titanium (Ti), sodium (Na), and bromine (Br).

3. The method of claim 1, wherein the one or more inert elements are selected from the group consisting of lithium (Li), boron (B), aluminum (Al), phosphorous (P), sulfur(S), potassium (K), calcium (Ca), scandium (Sc), vanadium (V), chromium (Cr), manganese (Mn), iron (Fe), cobalt (Co), nickel (Ni), copper (Cu), zinc (Zn), gallium (Ga), strontium (Sr), zirconium (Zr), niobium (Nb), molybdenum (Mo), indium (In), lanthanum (La), cerium (Ce), tantalum (Ta), tungsten (W), and bismuth (Bi).

4. The method of claim 1, wherein the reaction conditions comprise introducing a reducing agent having a reducing potential more negative than any of the one or more precursors dissolved in the liquid solvent.

5. The method of claim 1, wherein the reaction conditions comprise introducing a reducing agent having a reducing potential more negative than −1V vs. a standard hydrogen electrode.

6. The method of claim 1, wherein the liquid solvent forming the homogenous liquid-phase mixture is selected from the group consisting of an organic solvent and an ionic liquid.

7. The method of claim 6, wherein the liquid solvent is the organic solvent selected from the group consisting of an alkane, alkene, arene, ether, halogenated solvent, ester, amide, nitrile, and carbonate.

8. The method of claim 1, wherein the homogenous liquid-phase mixture is free from any solid species before reacting the one or more precursors using the reaction conditions.

9. The method of claim 1, wherein the one or more precursors are reacted electrochemically in an electrochemical fabrication cell comprising two electrodes operating at a voltage between 2.5V to 6V.

10. The method of claim 1, wherein the one or more precursors are reacted chemically or electrochemically at a temperature less than 300° C.

11. The method of claim 1, wherein the one or more precursors comprise a single precursor comprising both the silicon and the one or more inert elements in the single precursor.

12. The method of claim 11, wherein:
the single precursor is selected from the group consisting of an organosilane and a silazane,
the organosilane is selected from the group consisting of trichlorosilane, trichloromethylsilane (SiHCl3), trichloroethylsilane, (SiCH3Cl₃), trichlorophenylsilane (Si(C₆H₅)Cl₃), and dichlorodimethylsilane (Si(CH₃)₂Cl₂), and chloro(dimethyl)phenylsilane, and
the silazane is selected from the group consisting of hexamethyldisilazane (C₆H₁₉NSi₂) and 2,2,4,4,6,6-hexamethylcyclotrisilazane.

13. The method of claim 1, wherein:
the one or more precursors comprise a first precursor comprising silicon and a second precursor comprising the one or more inert elements, and
the second precursor has a different composition than the first precursor.

14. The method of claim 1, wherein the one or more precursors comprise a silicon-generating precursor selected from the group consisting of silicon tetrachloride (SiCl₄), di-silicon hexachloride (Si₂Cl₆), silicon tetrabromide (SiBr₄), silicon tetraiodide (SiI₄), silane (SiH₄), di-silane (Si₂H₆), and tri-silane (Si₃Hg).

15. The method of claim 1, wherein the one or more precursors comprise a carbon-generating precursor selected from the group consisting of cholorobenzene (C₆H₅Cl), dicholorbenze (C₆H₄Cl₂), trichlorobenze (C₆H₃Cl₃), hexacholorbenzene (C₆Cl₆), dibromobenzene (C₆H₄Br₂), chloromethane (CH₃Cl), dicholoromethane (CH₂Cl₂), trichloromethane (CHCl₃), tetrachloro carbon (C₂Cl₄), and tetrabromo carbon (CBr₄).

16. The method of claim 1, wherein:
the one or more precursors comprise a halide selected from the group consisting of a metal halide, a non-metal halide, an amine, and an amide,
the metal halide is selected from the group consisting of lithium chloride (LiCl), titanium tetrachloride (TiCl₄), iron (III) chloride (FeCl₃), aluminum chloride (AlCl₃), and magnesium chloride (MgCl₂),
the non-metal halide selected from the group consisting of phosphorus trichloride (PCl₃), phosphorus pentachloride (PCl₅), boron trichloride (BCl₃),
the amine selected from the group consisting of trimethylamine ((CH₃)₃N) and melamine (C₃H₆N₆), and
the amide selected from the group consisting of dimethylformamide (C₃H₇NO).

17. The method of claim 1, wherein:
the one or more precursors comprise one or more oxygen-generating precursors selected from the group consisting of water (H₂O), dissolved oxygen, carbon dioxide (Co₂), an alcohol, an oxalate salt, and a nitrate salt, and
the electrochemically active-material structures further comprise oxygen.

18. The method of claim 1, further comprising heat treating the electrochemically active-material structures at a temperature of 50-1100° C.

19. The method of claim 1, wherein:
the homogenous liquid-phase mixture is an electrolyte, provided in an electrochemical fabrication cell comprising two electrodes,
the reaction conditions comprise applying a voltage of 2.5-6V between the two electrodes of the electrochemical fabrication cell, and
the electrochemically active-material structures comprise at least carbon or oxygen as the one or more inert elements.

20. The method of claim 1, wherein:
the reaction conditions comprise adding lithium biphenyl solution dissolved in tetrahydrofuran (THF) to trigger a chemical reaction to form the electrochemically active-materials, and
the electrochemically active-material structures comprise at least carbon or oxygen as the one or more inert elements.
